(19) United States
(12) Patent Application Publication
(10) Pub. No.: US 2023/0033928 A1
(43) Pub. Date: Feb. 2, 2023

(54) HEAD FOR BRUSH CUTTERS

(71) Applicant: TECOMEC S.R.L., Reggio Emilia (RE) (IT)

(72) Inventor: Enrico Cigarini, Reggio Emilia (IT)

(21) Appl. No.: 17/645,486

(22) Filed: Dec. 22, 2021

(30) Foreign Application Priority Data
Jul. 30, 2021 (IT) 102021000020423

(51) Int. Cl. A01G 20/43; A01D 42/00; A01D 34/73

(52) U.S. Cl. CPC A01G 20/43; A01D 42/005; A01D 34/73; A01D 2101/00

(57) ABSTRACT

A head 1 for brush cutter suitable for cutting grass and herbaceous plants having a support element 2, rotatable about a vertical axis Y-Y thereof, connected to a series of first pins 3 and a series of second pins 4. The series of first pins 3 is coupled to a first plurality of cutting elements 5 and the series of second pins 4 is coupled to a second plurality of cutting elements 6.

Said first plurality of cutting elements 5 defines a cutting plane P1 and said second plurality of cutting elements defines a second cutting plane P2, spaced apart from the previous one. The first and second plurality of cutting elements 5, 6 having, over an angular sector of 360° , an alternating arrangement.

The invention relates to a cutting head for brush cutter machines. Machines for cutting vegetation, such as brush cutters, can use different types of cutting tools, depending on the type of vegetation to be cut. The cutting tools are fixed in a cutting head, coupled to a rotating shaft of the brush cutter. When rotated with the cutting head about the axis of the shaft, the tool covers a circular surface which extends around the axis of the shaft, the diameter of this surface is called the cutting diameter. Said cutting diameter is the diameter of the circle described by the end of the cutting tool during the rotation of the cutting head.

Cutting filaments are a first type of cutting tool intended mainly for cutting grass or edging. Such cutting filaments are generally made of plastic obtained from an extrusion process. At least one filament is fixed in the cutting head and a free end of the filament exits from the head through an eyelet. Cutting filaments can have several drawbacks. Firstly, such filaments are prone to abrasion or breakage, thus requiring frequent filament changes, which is annoying and time consuming. Furthermore, the energy consumption is high for large filament diameters. Furthermore, due to its flexibility, the filament tends to slam during its rotation, which generates a noticeable noise, requiring the user to wear individual hearing protection. Lastly, the cutting heads configured to receive the filaments usually have a complex design and can be difficult to use, especially for non-professional users.

Plastic cutting blades are a second type of cutting tool having a shape similar to the blade of a knife, mainly intended for cutting dense or hard vegetation. However, such cutting blades are affected by several disadvantages. Firstly, the blade can break into several pieces following an impact on a particularly hard obstacle, such as a stone, a log or a tree trunk, etc. These pieces can be projected several metres around the cutting head with the risk of seriously injuring the user or other people nearby. Furthermore, depending on the shape of the blades and the way they are fastened to the cutting head, the energy consumption of the brush cutter can be very high. Lastly, the cutting blades are usually much more expensive than the cutting filaments.

Metal discs are a third type of cutting tool, mainly used in regions with dense or dry vegetation. Metal discs also have a number of drawbacks, in particular the generation of sparks resulting from contact with a stone, which can trigger a fire. Furthermore, such discs are very dangerous to use due to the high risk of injury. Lastly, similar to plastic cutting blades, metal discs can also break into different pieces following an impact with a hard obstacle.

To date, none of the above-mentioned cutting tools provides a fully satisfactory solution.

In particular, there is a growing demand for machines for cutting vegetation with a mulching function. Such machines allow to cut the vegetation into small pieces which dry quickly and are therefore able to decompose easily in the soil. With such machines the user is not required to collect the vegetation residues after cutting, thus avoiding a tiring job and saving a great deal of time. Furthermore, said vegetation residues contribute to the fertilisation of the soil.

Energy consumption is also a growing problem for brush cutters. These machines are often fuelled with gasoline, especially for professional use where the machine must be used for several hours at a time.

In order to reduce the air pollution caused by petrol engines, electrically powered brush cutters have been developed. To this end, the machine for cutting vegetation is connected to an electric battery which is located for example in a rucksack held by a user.

However, the power and autonomy of these brush cutters remain limited. In particular, the energy consumption of the machine is linked to the aerodynamic resistance and the cutting efficiency of the tool used (cutting filament or blade). The battery level can thus rapidly decrease. Consequently, battery-powered lawnmowers are mainly dedicated to non-professional use.

To make electrically powered machines for cutting vegetation compatible with professional use, the energy consumption should be greatly reduced. Therefore, an object of the invention is to design a cutting head which overcomes the aforementioned disadvantages related to the existing cutting tools, provides a mulching function and minimises the energy consumption of a brush cutter.

To this end, the object of the invention is to define a cutting head for a brush cutting machine, according to claim 1.

In the present text, the term “planar” means that the cutting element generally extends in at least two directions of a plane, as opposed to a cutting filament which is considered, in the context of the present text, as a linear cutting tool, as it extends mainly along a main direction of a plane. In particular, the cutting edge of the disc extends in a plane. Said plane is typically perpendicular to the axis of rotation of the disc.

In the present text, the term “coplanar” means that a group of cutting elements lies on the same plane or at the same height with respect to a reference surface.

In the present text, the term “freely rotatable” means that the cutting disc can make full rotations about the pin (a complete rotation covering an angular sector of 360°), in both directions. In this regard, the cutting head does not comprise any component capable of limiting the rotation range of the cutting disc. When the cutting head rotates within a certain speed range, the centrifugal force applied to the cutting disc can cause the disc to block against the pin by means of a support pillar. Thus, the cutting disc rotates at the same speed as the head and acts as a cutting edge of the head. However, in the event of an impact on a significant obstacle, the force exerted by the obstacle on the disc can cancel the action of the support pillar and rotate the disc in a direction opposite the rotation direction of the head, which prevents the breakage of the disc and reduces the energy consumption of the machine because the rotation speed of the head always remains constant despite the impacts with the vegetation.

Furthermore, the arrangement of the cutting discs in different planes allows to capture the vegetation between two discs and cut it into small pieces. Therefore, the cutting head also has a mulching function, by virtue of which the user does not have to collect the vegetation residues after cutting.

The dependent claims correspond to possible embodiments of the invention.

Further features and advantages of the present invention will become more apparent from the following indicative and therefore non-limiting description,

of a preferred but not exclusive embodiment of a brush cutter head as illustrated in the accompanying drawings in which:

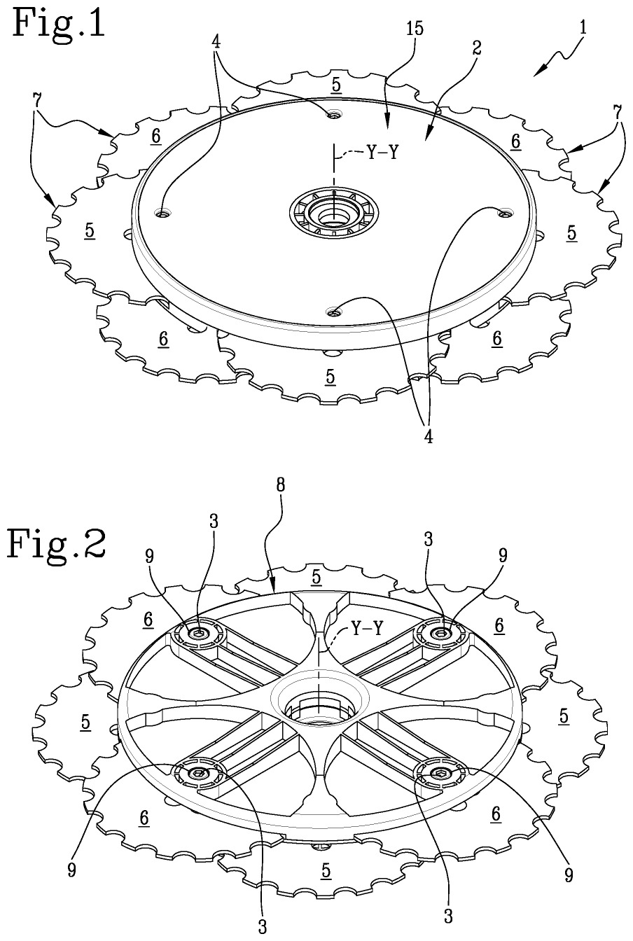

FIG. 1 is a perspective view from below of a head in accordance with the present invention;

FIG. 2 is a perspective view from above of the head of FIG. 1 with some parts removed to better highlight others;

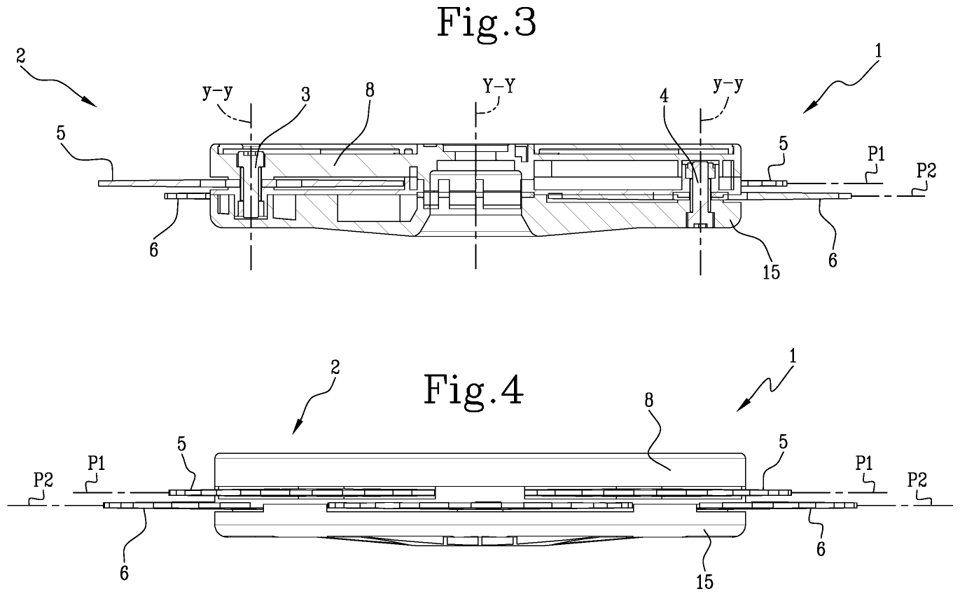

FIG. 3 is a transversal sectional view of the head of FIGS. 1 and 2;

FIG. 4 is a lateral view of the head;

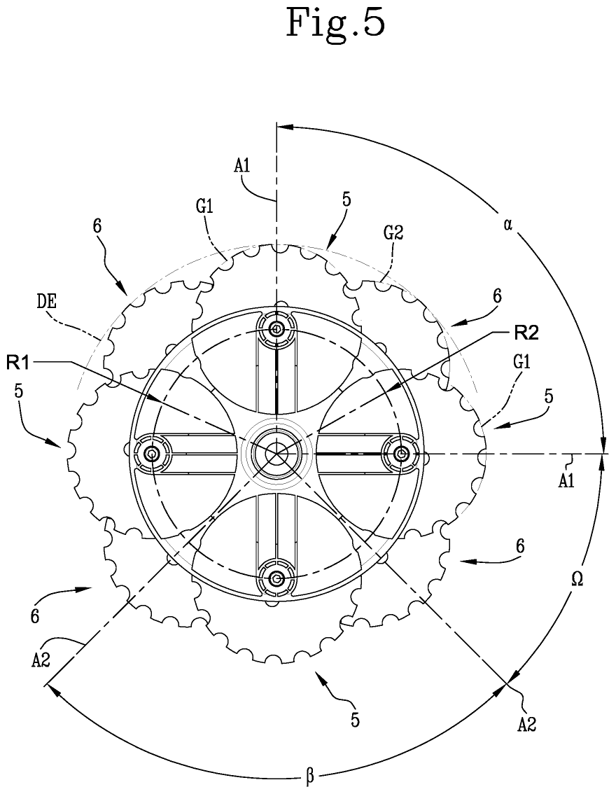

FIG. 5 is a projection plan view of the head;

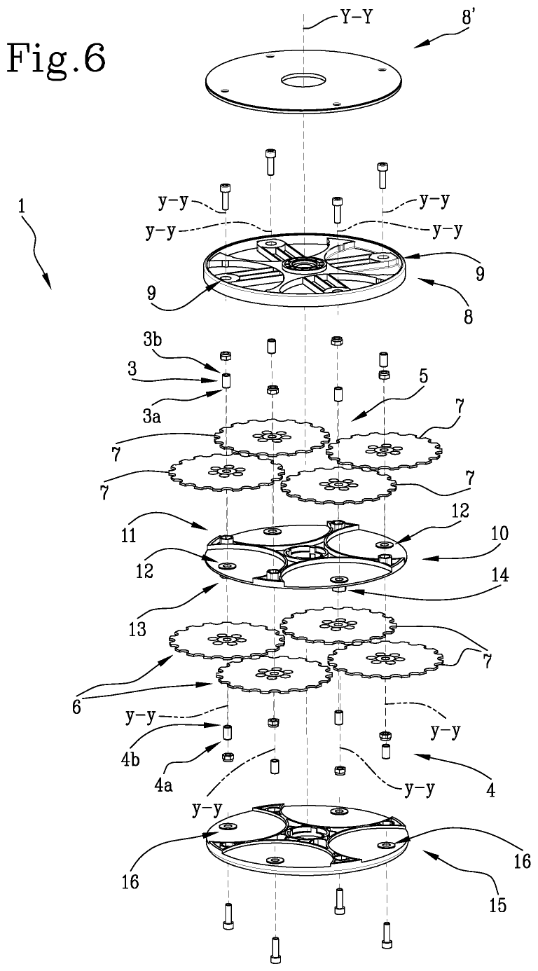

FIG. 6 is an exploded view of the head;

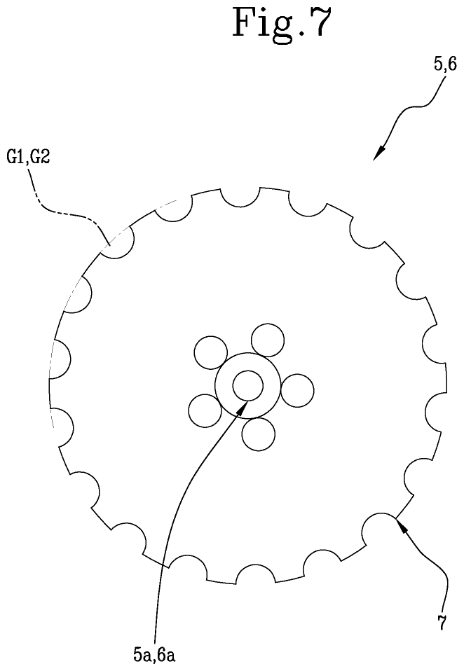

FIG. 7 illustrates a detailed view of a component of the head.

With reference to the accompanying figures, the number 1 indicates overall a head for brush cutters suitable for cutting grass and herbaceous plants and in particular suitable for mulching-effect cutting.

The term mulching generally refers to covering the soil with a layer of material, preferably organic, in order to create a layer above that of the turf which is adapted to maintain soil moisture, protecting the soil from erosion and avoiding the formation of the so-called surface crust.

Organic materials for mulching can be among the most varied. To name a few: straw, dried leaves, bark, and mowing grass. Mulching-effect cutting is an operation through which the brush cutter, due to the centrifugal force exerted by the brush cutter to the head at the same time as cutting the grass, spreads the cut grass around the area in which the cutting has just been carried out.

The head 1 can be associated with a brush cutter, which is substantially known and therefore not illustrated. A rotary motion is transmitted through a motor, whether by means of a spark or battery, to a drive shaft connected at one end to the motor and at the other end to the support element 2.

The support element 2 has a vertical axis Y-Y about which it can rotate when moved by the drive shaft.

The support element 2 generally has a circular or otherwise axial symmetrical shape so as not to induce imbalances to the drive shaft during the rotation about its axis.

In a preferred embodiment, illustrated in greater detail in FIG. 6, the support element 2 comprises an upper element 8 (optionally covered by a casing 8′), an intermediate element 10 and a lower element 15. The aforesaid three elements are removable from each other in an open configuration, in which they are spaced apart from one another, to replace the cutting elements 5, better described below, to an assembled configuration, in which they are packed together, during which the operator proceeds to cut the grass.

The intermediate element 10 has a first and a second side 11, 13 opposite each other.

The first side 11 faces the upper element 8 and in the distanced configuration is away from the upper element 8 while in the mounted configuration it is closed in a pack against the upper element 8.

The second side 13 faces the lower element 15 and in the distanced configuration is away from the lower element 15 while in the mounted configuration it is closed in a pack against the lower element 15.

The support element 2 includes a series of first pins 3 and a series of second pins 4. As can be seen in the accompanying drawings, the first pins 3 include a radial distribution on the support element 2 and, similarly, the second pins 4 also include a radial distribution on the support element 2. In particular, in the preferred embodiment illustrated, the series of second pins 4 is angularly spaced with respect to the series of first pins 3.

Thereby every first pin 3 is flanked by a pair of second pins 4 and vice versa every second pin 4 is flanked by a pair of first pins 3. Each pin, belonging to the first or second series 3, 4 preferably has a cylindrical shape with a base 3a or 4a, a top 3b or 4b and an extension axis y-y preferably parallel to the vertical axis Y-Y of the support element 2.

The series of first pins 3 is distributed over a first radius R1 of the support element 2 and the series of second pins 4 is distributed over a second radius R2 of the support element 2.

The first and second radii R1 and R2 are centred on the vertical axis Y-Y.

The first and second radii R1 and R2 preferably have the same amplitude. Without leaving the field of protection of the present invention, R1 and R2 can have different amplitudes.

The extension axis y-y of each pin belonging to the series of first pins 3 lies on a circumference having radius R1 and centre in the vertical axis Y-Y.

The extension axis y-y of each pin belonging to the second series of pins 4 lies on a circumference having radius R2 and centre in the vertical axis Y-Y. The series of first pins 3 is distributed on first radial generatrices A1, all passing through the vertical axis Y-Y of the support element 2, spaced apart from one another by a first angle a, preferably comprised between 15 and 90 degrees.

In other words, the first angle a is the angle subtended between two contiguous pins belonging to the series of first pins 3, i.e., the angle subtended between two first radial generatrices A1.

The series of second pins 4 is distributed on second radial generatrices A2, all passing through the vertical axis Y-Y of the support element 2, spaced apart from one another by a second angle β, preferably comprised between 15 and 90 degrees.

As before, the second angle 13 is the angle subtended between two contiguous pins belonging to the series of second pins 4, i.e., the angle subtended between two second radial generatrices A2.

Each first angle α, subtended by the pair of first radial generatrices A1 (defined by a pair of first contiguous pins 3), is spaced apart from each second angle β, subtended by a pair of second radial generatrices A2 (contiguous to the pair of first radial generatrices A1 and defined by a pair of second pins 4), by a third angle Ω, preferably comprised between 7.5 and 45 degrees.

To provide an example, illustrated in the accompanying drawings, a pin, belonging to the first series of pins 3, is spaced apart from a contiguous pin belonging to the same series of first pins 3 by a first angle a equal to 90 degrees, and a pin belonging to the second series 4, is spaced apart from a contiguous pin belonging to the same series of second pins 4 by a second angle β equal to 90 degrees. The first angle a is then spaced apart from the second angle β by a third angle Ω equal to 45 degrees.

With reference to the preferred coupling between the first and second series of pins 3, 4 and the discoid element 2, it can be seen that the support element 2 is engaged, through the upper element 8 and the intermediate element 10, with the series of first pins 3 and, through the lower element 15 and the intermediate element 10, with the series of second pins 4.

In more detail, the upper element 8 has a plurality of upper seats 9. At the first side 11 there is a plurality of upper intermediate seats 12 facing and in axis with the plurality of upper seats 9 so as to accommodate and trap the series of first pins 3.

Said plurality of upper intermediate seats 12 and plurality of upper seats 9 cooperate with each other to intercept the series of first pins 3.

At the second side 13 there is a plurality of lower intermediate seats 14 facing and in axis with a corresponding plurality of lower seats 16 obtained in the lower element 15.

Also in this case, the plurality of lower intermediate seats 14 collaborates with the plurality of lower seats 16 to intercept the series of second pins 4. On the series of first pins 3 a first plurality of cutting elements 5 are coupled and on the series of second pins 4 a second plurality of cutting elements 6 are coupled.

As can be seen in the accompanying drawings, the first and second plurality of cutting elements 5, 6 are preferably defined by a plurality of discoid elements each having a plurality of teeth 7 on the periphery thereof.

Without leaving the field of protection of the present invention, each cutting element belonging to the respective pluralities 5, 6 can take any form such as: polygonal blades, triangular blades, elliptical blades.

The coupling between the series of first pins 3 and the corresponding first plurality of cutting elements 5 and between the series of second pins 4 and the corresponding second plurality of cutting elements 6 is preferably of the idle type.

In other words, each cutting element has a central hole 5a or 6a having a greater diameter with than the outer diameter of the corresponding pin 3 or 4 to which it couples.

Various rotation configurations of the plurality of cutting elements 5, 6 with respect to the support element 2 can thus be obtained. At a first angular acceleration speed of the support element 2, the plurality of cutting elements 5, 6 can result in a rest position and can rotate on the axis y-y thereof with speeds synchronous to each other. When the angular speed of the support element has reached the operating speed, the plurality of cutting elements 5, 6 can rotate on the axis y-y thereof with synchronous speeds.

With reference to the first plurality of cutting elements 5, each cutting element is coplanar with the other cutting elements belonging to the plurality 5. Thereby, each cutting element belonging to the first plurality 5 lies with the other cutting elements on a first cutting plane P1.

Likewise, the second plurality of cutting elements 6 have all the cutting elements coplanar with each other so as to define a second cutting plane P2. In other words, each cutting element belonging to the second plurality lies with the other cutting elements on a second cutting plane P2.

The first and second cutting planes P1 and P2 are parallel and distanced from each other by a spacing comprised between 0.5 mm and 10 mm. As a result of the idle coupling between the series of first pins 3 and the respective first plurality of cutting elements 5 and between the series of second pins 4 and the respective second plurality of cutting elements 6, upon rotation of the support element 2 the cutting elements can rotate with synchronous or asynchronous speed.

Thereby, as a result of the possible different rotation of the cutting elements 5, 6 and as a result of the arrangement on two cutting planes P1, P2 thereof, the grass is not cut in a single point but is cut in several points, then chopped, thus achieving the mulching-effect cutting.

The arrangement of the first plurality of cutting elements 5 and the second plurality of cutting elements 6 is alternating.

In other words, each cutting element 5 belonging to the first plurality of cutting elements 5 is interposed between a pair of cutting elements 6 belonging to the second plurality of cutting elements 6. And vice versa.

In other words, each first cutting element 5 has in a near position a pair of second cutting elements 6, distributed on the second cutting plane P2 and on opposite sides with respect to the first pin 3 on which the first cutting element 5 is coupled, and in a distanced position with respect to a pair of first cutting elements 5, distributed on the first cutting plane P1 and on opposite sides with respect to the first pin 3 on which the first cutting element 5 is coupled.

Each second cutting element 6 has in a near position a pair of first cutting elements 5, distributed on the first cutting plane P1 and on opposite sides with respect to the second pin 4 on which the second cutting element 6 is coupled, and in a distanced position with respect to a pair of second cutting elements 6, distributed on the second cutting plane P2 and on opposite sides with respect to the second pin 4 on which the second cutting element 6 is coupled.

Each cutting element 5, when rotated by the support element 2, defines a first circular generatrix G1. Likewise, each cutting element 6, when rotated by the support element 2, defines a second circular generatrix G2.

Taking a horizontal plane as a reference, when the support element 2 includes the vertical axis Y-Y thereof in a position perpendicular to the aforesaid horizontal plane, a first circular generatrix G1, defined by a first cutting element 5, is on opposite sides that are tangent or secant to a pair of second circular generatrices G2, defined by a second pair of cutting elements 6, adjacent to the first cutting element 5.

Likewise, a second circular generatrix G2, defined by a second cutting element 6, is on opposite sides that are tangent or secant to a pair of first circular generatrices G1 defined by a first pair of cutting elements 5 contiguous with the second cutting element 6.

Thereby, the head 1 has an outer cutting diameter DE, when the head 1 is at rest, which is the closest to a circumference. Through this particular arrangement of the cutting elements it is possible to generate an outer cutting diameter DE of the head with the least number of recesses. In doing so, when the support element 2 is rotated, the head 1 achieves a more uniform cutting behaviour. Secondly, if the support element is unintentionally directed against an obstacle, the cutting elements 5, 6 absorb and distribute the impact so as to induce less vibration to the brush cutter and so as to safeguard the integrity of the cutting elements 5, 6 as much as possible.

As can be seen from the accompanying drawings, said first and second plurality of cutting elements 5, 6 each comprise a number of cutting elements comprised between 3 and 6, preferably 4 cutting elements for each plurality of cutting elements 5, 6.

It is therefore noted that the present invention achieves the proposed objects by making a head which is capable of cutting the grass even with the mulching effect.

Due to the arrangement of the cutting elements on two cutting planes P1 and P2 it is possible to cut the grass in several points rather than in a single point.

Secondly, the arrangement of the cutting elements allows to reduce the noise of the tool during the working steps, to minimise vibrations due to impacts with obstacles and to safeguard the duration of the cutting tools as much as possible.

1. A head (1) for a brush cutter, suitable for cutting grass and herbaceous plants and in particular for cutting with a mulching effect, of the type comprising:
a support element (2), connectable to a drive shaft of the brush cutter so as to be set in rotation about a vertical axis thereof (Y-Y);
a series of first pins (3) radially distributed over the support element (2);
a series of second pins (4) radially distributed over the support element (2); said series of second pins (4) being angularly spaced relative to the series of first pins (3);
a first plurality of cutting elements (5) coupled to the series of first pins (3); each cutting element (5) having its own rotation axis (y-y) and being induced to rotate about its axis (y-y) due to the rotation of the support element (2), thereby defining a respective first circular cutting generatrix (G1);
a second plurality of cutting elements (6) coupled to the series of second pins (4); each cutting element (6) having its own rotation axis (y-y) and being induced to rotate about its axis (y-y) due to the rotation of the support element (2), thereby defining a respective second circular cutting generatrix (G2);
characterised in that:
each first cutting element (5) is coplanar with the other cutting elements belonging to the first plurality (5) so as to define a first cutting plane (P1);
each second cutting element (6) is coplanar with the other cutting elements belonging to the second plurality (6) so as to define a second cutting plane (P2) distanced from the first cutting plane (P1);
said first plurality of cutting elements (5) is distributed over an angular sector of 360° , with an alternating arrangement relative to said second plurality of cutting elements (6) and vice versa, so that each first cutting element (5) is interposed between a pair of cutting elements belonging to the second plurality of cutting elements (6) and each second cutting element (6) is interposed between a pair of cutting elements belonging to the first plurality of cutting elements (5).

2. The head (1) according to claim 1, wherein each first cutting element (5) has, in a near position, a pair of second cutting elements (6), distributed over the second cutting plane (P2) and on opposite sides relative to the first pin (3) onto which the first cutting element (5) is coupled and, in a distanced position, a pair of first cutting elements (5), distributed over the first cutting plane (P1) and on opposite sides relative to the first pin (3) onto which the first cutting element (5) is coupled and wherein each second cutting element (6) has, in a near position, a pair of first cutting elements (5), distributed over the first cutting plane (P1) and on opposite sides relative to the second pin (4) onto which the second cutting element (6) is coupled and in a distanced position a pair of second cutting elements (6), distributed over the second cutting plane (P2) and on opposite sides relative to the second pin (4) onto which the second cutting element (6) is coupled.

3. The head (1) according to claim 1, wherein said series of first pins (3), is distributed over a first radius (R1) of the support element (2) and said series of second pins (4) is distributed over a second radius (R2) of the support element (2); said first radius (R1) preferably having an extent that is substantially equal to that of the second radius (R2).

4. The head (1) according to claim 1, wherein said series of first pins (3) is distributed over first radial generatrices (A1), all passing through the axis (Y-Y) of the support element (2), spaced apart from one another by a first angle (α), and wherein said series of second pins (4) is distributed over second radial generatrices (A2), all passing through the axis (Y-Y) of the support element (2), spaced apart from one another by a second angle (β); said first angle (α), defined between a pair of first radial generatrices (A1), being spaced apart from a second contiguous angle (β), defined by a pair of second radial generatrices (A2) contiguous to the pair of first radial generatrices (A1), by a third angle (Ω).

5. The head (1) according to claim 1, wherein, when the support element (2) has its vertical axis (Y-Y) perpendicular to a horizontal plane, the projection of a first cutting generatrix (G1) on the horizontal plane, belonging to a first cutting element (5), is tangent or secant, on opposite sides, to the projections of two respective second generatrices (G2) belonging to a pair of corresponding second cutting elements (6) contiguous to the first cutting element (5) and the projections of a second cutting generatrix (G2) on the horizontal plane, belonging to a second cutting element (6), is tangent or secant, on opposite sides, to the projections of two respective first generatrices (G1) belonging to a pair of corresponding first cutting elements (5) contiguous to the second cutting element (6).

6. The head (1) according to claim 1, wherein the first and second plurality of cutting elements (5) are defined by discoid elements, each having a plurality of teeth (7) on the periphery thereof.

7. The head (1) according to claim 1, wherein said support element (2) comprises:
an upper element (8), preferably having a discoid shape and having a plurality of upper seats (9);
an intermediate element (10), coupled to the upper element (8), having on a first side (11), facing the upper element (8), a plurality of upper intermediate seats (12) and, on a second side (13), opposite the first side (11), a plurality of lower intermediate seats (14); said plurality of upper seats (9) and said plurality of upper intermediate seats (12) retaining inside them the series of first pins (3) by virtue of the coupling of the intermediate element (10) to the upper element (8);
a lower element (15), preferably having a discoid shape, facing the second side (13) and coupled to the intermediate element (10) and having a plurality of lower seats (16); said plurality of lower seats (16) and said plurality of lower intermediate seats (14) retaining inside them the series of second pins (4) by virtue of the coupling of the intermediate element (10) to the lower element (15).

8. The head (1) according to claim 1, wherein said first and said second plurality of cutting elements (5, 6) each comprises a number of cutting elements comprised between 3 and 6, preferably 4 cutting elements for every plurality of cutting elements (5, 6).

9. The head (1) according to claim 1, wherein said first cutting plane (P1) is set at a distance from the second cutting plane (P2) comprised between 0.5 and 10 mm.
